(19) United States
(12) Patent Application Publication
(10) Pub. No.: US 2020/0402085 A1
(43) Pub. Date: Dec. 24, 2020

(54) MIGRATION TENDENCY ESTIMATION DEVICE, MIGRATION TENDENCY ESTIMATION METHOD, AND PROGRAM

(71) Applicant: NIPPON TELEGRAPH AND TELEPHONE CORPORATION, Tokyo (JP)

(72) Inventors: Yasunori AKAGI, Tokyo (JP); Hiroyuki TODA, Tokyo (JP); Takeshi KURASHIMA, Tokyo (JP); Takuya NISHIMURA, Tokyo (JP)

(73) Assignee: NIPPON TELEGRAPH AND TELEPHONE CORPORATION, Tokyo (JP)

(21) Appl. No.: 16/969,491

(22) PCT Filed: Feb. 14, 2019
(86) PCT No.: PCT/JP2019/005373

§ 371 Date: Aug. 12, 2020

(30) Foreign Application Priority Data
Feb. 14, 2018 (JP) 2018-024435

(51) Int. Cl. G06Q 30/02

(52) U.S. Cl. CPC G06Q 30/0204

(57) ABSTRACT

The probability of migration and the number of migrating persons with high accuracy and a small amount of calculation can be estimated even when migrations to areas other than adjacent areas are taken into consideration. A parameter estimation unit 120 estimates a first parameter indicating the likelihood of departure from the area to the other area and a second parameter indicating the likelihood of gathering of persons in the area for each of the plurality of areas, a third parameter indicating an influence on the probability of migration of a distance between the areas, and the number of migrating persons from the area to each of the other areas for each of the plurality of areas on the basis of the demographic information. A migration probability calculation unit 170 calculates the probability of migration from the area to each of the other areas for each of the plurality of areas on the basis of the first parameter, the second parameter, and the third parameter.

### TECHNICAL FIELD

The present invention relates to a migration tendency estimation device, a migration tendency estimation method, and a program, and more particularly, relates to a migration tendency estimation device, a migration tendency estimation method, and a program for estimating the probability of migration and the number of migrating persons from demographic information with high accuracy.

### BACKGROUND ART

Conventionally, position information of persons obtained from GPS or the like has sometimes been provided as demographic information with which it is not possible to track individuals because of privacy issues. Demographic information is information on the number of persons present in respective areas at each time point (time step). An area is a geographic space partitioned in a grid form, for example.

There are demands for estimating the probability of migration and the number of migrating persons between areas between time steps from such demographic information.

A technique for estimating the probability of migration and the number of migrating persons between respective areas from demographic information under an assumption that persons migrate between adjacent areas only using a framework (Collective Graphical Model, NPL 1) that estimates individual probability models from collected data is known (NPL 2).

### CITATION LIST

### Non Patent Literature

[NPL 1] D. R. Sheldon and T. G. Dietterich. Collective Graphical Models. In Proceedings of the 24th International Conference on Neural Information Processing Systems, 2011, pp. 1161-1169. [NPL 2] T. Iwata, H. Shimizu, F. Naya, and N. Ueda. Estimating People Flow from Spatiotemporal Population Data via Collective Graphical Mixture Models. ACM Transactions on Spatial Algorithms and Systems, Vol. 3, No. 1, May 2017, pp. 1-18.

### SUMMARY OF THE INVENTION

### Technical Problem

In NPL 2, the candidates for a migration destination from a certain area i are limited to the area i and those areas adjacent to the area i.

Such a limitation is effective when the area is sufficiently large and the time step widths are small. This is because a person cannot migrate a long distance in a short time width, and the size of an area is large, a greater part of the migrations occur in the same area or the adjacent areas.

However, this assumption sometimes does not hold depending on the type of data and the size of an area. For example, when the area size is small and the time step interval is short and when data including many long-distance migrations is handled, since migrations to areas other than the adjacent areas increase, this assumption does not hold.

When the above-mentioned method is applied to such data, estimation accuracy decreases greatly. Therefore, it is necessary to take migrations to areas other than adjacent areas into consideration in order to realize high-accuracy estimation.

However, there are two problems when migrations to areas other than adjacent areas are taken into consideration.

A first problem is that, when migrations to areas other than adjacent areas are simply taken into consideration, the degree of freedom of models may become extremely high, a solution may not be narrowed down, and a solution far from the true value may be output.

A second problem is the increase in the amount of calculation. In order to estimate parameters and the number of migrating persons between areas, it is necessary to solve an iterative optimization problem. When migrations to areas other than adjustments are taken into consideration, since it is necessary to solve an optimization problem having a large size many times, the amount of calculation becomes extremely large.

With the foregoing in view, an object of the present invention is to provide a migration tendency estimation device, a migration tendency estimation method, and a program capable of estimating the probability of migration and the number of migrating persons with high accuracy and a small amount of calculation even when migrations to areas other than adjacent areas are taken into consideration.

### Means for Solving the Problem

A migration tendency estimation device according to the present invention is a migration tendency estimation device that estimates the number of migrating persons and a probability of migration from an area to another area at each time point for each of a plurality of areas from demographic information including population information at each time point of the area, the migration tendency estimation device including: a parameter estimation unit that estimates a first parameter indicating the likelihood of departure from the area to the other area and a second parameter indicating the likelihood of gathering of persons in the area for each of the plurality of areas, a third parameter indicating an influence on the probability of migration of a distance between the areas, and the number of migrating persons from the area to each of the other areas for each of the plurality of areas on the basis of the demographic information; and a migration probability calculation unit that calculates the probability of migration from the area to each of the other areas for each of the plurality of areas on the basis of the first parameter, the second parameter, and the third parameter.

A migration tendency estimation method according to the present invention is a migration tendency estimation method for estimating the number of migrating persons and a probability of migration from an area to another area at each time point for each of a plurality of areas from demographic information including population information at each time point of the area, the migration tendency estimation method including: allowing a parameter estimation unit to estimate a first parameter indicating the likelihood of departure from the area to the other area and a second parameter indicating the likelihood of gathering of persons in the area for each of the plurality of areas, a third parameter indicating an influence on the probability of migration of a distance between the areas, and the number of migrating persons from the area to each of the other areas for each of the plurality of areas on the basis of the demographic information; and allowing a migration probability calculation unit to calculate the probability of migration from the area to each of the other areas for each of the plurality of areas on the basis of the first parameter, the second parameter, and the third parameter.

According to the migration tendency estimation device and the migration tendency estimation method according to the present invention, the parameter estimation unit estimates a first parameter indicating the likelihood of departure from the area to the other area and a second parameter indicating the likelihood of gathering of persons in the area for each of the plurality of areas, a third parameter indicating an influence on the probability of migration of a distance between the areas, and the number of migrating persons from the area to each of the other areas for each of the plurality of areas on the basis of the demographic information.

The migration probability calculation unit calculates the probability of migration from the area to each of the other areas for each of the plurality of areas on the basis of the first parameter, the second parameter, and the third parameter.

The first parameter indicating the likelihood of departure from an area to another area and the second parameter indicating the likelihood of gathering of persons to the area for each of a plurality of areas, and the third parameter indicating the influence on the probability of migration of the distance between areas, and the number of migrating persons from the area to each of the other areas for each of the plurality of areas are estimated on the basis of the demographic information, and the probability of migration from the area to each of the other areas is calculated for each of the plurality of areas on the basis of the first parameter, the second parameter, and the third parameter. Therefore, even when migration to an area other than adjacent areas is taken into consideration, it is possible to estimate the probability of migration and the number of migrating persons with high accuracy and a small amount of calculation.

Moreover, the parameter estimation unit of the migration tendency estimation device according to the present invention can estimate the first parameter, the second parameter, the third parameter, and the number of migrating persons so as to optimize an objective function indicating the likelihood of the number of migrating persons determined using the first parameter, the second parameter, the third parameter, and the demographic information.

A migration tendency estimation device according to the present invention is a migration tendency estimation device that estimates the number of migrating persons and a probability of migration from an area to another area at each time point for each of a plurality of areas from demographic information including population information at each time point of the area, the migration tendency estimation device including: a parameter estimation unit that estimates a first parameter indicating the likelihood of departure from the area to the other area and a second parameter indicating the likelihood of gathering of persons in the area for each of the plurality of areas, a third parameter indicating an influence on the probability of migration of a distance between the areas, and the total number of migrating persons obtained by summing the numbers of migrating persons for respective positional relationships between areas on the basis of the demographic information; a migration probability calculation unit that calculates the probability of migration from the area to each of the other areas for each of the plurality of areas on the basis of the first parameter, the second parameter, and the third parameter; and a number-of-migrating-persons estimating unit that estimates the number of migrating persons from the area to each of the other areas for each of the plurality of areas on the basis of the demographic information and the probability of migration calculated by the migration probability calculation unit.

A migration tendency estimation method according to the present invention is a migration tendency estimation method for estimating the number of migrating persons and a probability of migration from an area to another area at each time point for each of a plurality of areas from demographic information including population information at each time point of the area, the migration tendency estimation method including: allowing a parameter estimation unit to estimate a first parameter indicating the likelihood of departure from the area to the other area and a second parameter indicating the likelihood of gathering of persons in the area for each of the plurality of areas, a third parameter indicating an influence on the probability of migration of a distance between the areas, and the total number of migrating persons obtained by summing the numbers of migrating persons for respective positional relationships between areas on the basis of the demographic information; allowing a migration probability calculation unit to calculate the probability of migration from the area to each of the other areas for each of the plurality of areas on the basis of the first parameter, the second parameter, and the third parameter; and allowing a number-of-migrating-persons estimating unit to estimate the number of migrating persons from the area to each of the other areas for each of the plurality of areas on the basis of the demographic information and the probability of migration calculated by the migration probability calculation unit.

According to the migration tendency estimation device and the migration tendency estimation method according to the present invention, the parameter estimation unit estimates a first parameter indicating the likelihood of departure from the area to the other area and a second parameter indicating the likelihood of gathering of persons in the area for each of the plurality of areas, a third parameter indicating an influence on the probability of migration of a distance between the areas, and the total number of migrating persons obtained by summing the numbers of migrating persons for respective positional relationships between areas on the basis of the demographic information.

The migration probability calculation unit calculates the probability of migration from the area to each of the other areas for each of the plurality of areas on the basis of the first parameter, the second parameter, and the third parameter; and the number-of-migrating-persons estimating unit estimates the number of migrating persons from the area to each of the other areas for each of the plurality of areas on the basis of the demographic information and the probability of migration calculated by the migration probability calculation unit.

As described above, the first parameter indicating the likelihood of departure from the area to another area and the second parameter indicating the likelihood of gathering of persons in the area for each of the plurality of areas, the third parameter indicating the influence on the probability of migration of the distance between areas, and the total number of migrating persons obtained by summing the numbers of migrating persons for respective positional relationships between areas are estimated on the basis of the demographic information, the probability of migration from the area to each of the other areas is calculated on the basis of the first parameter, the second parameter, and the third parameter, and the number of migrating persons from the area to each of the other areas is estimated for each of the plurality of areas on the basis of the demographic information and the probability of migration. In this way, even when migration to areas other than adjacent areas is taken into consideration, it is possible to estimate the probability of migration and the number of migrating persons with high accuracy and a small amount of calculation.

Moreover, the parameter estimation unit of the migration tendency estimation device according to the present invention can estimate the first parameter, the second parameter, the third parameter, and the total number of migrating persons so as to optimize an objective function indicating the likelihood of the total number of migrating persons determined using the first parameter, the second parameter, the third parameter, and the demographic information.

A program according to the present invention is a program for causing a computer to function as each unit of the migration tendency estimation device.

### Effects of the Invention

According to a migration tendency estimation device, a migration tendency estimation method, and a program of the present invention, it is possible to estimate the probability of migration and the number of migrating persons with high accuracy and a small amount of calculation even when migrations to areas other than adjacent areas are taken into consideration.

### BRIEF DESCRIPTION OF DRAWINGS

FIG. 1 is a schematic diagram illustrating a configuration of a migration tendency estimation device according to a first embodiment of the present invention.

FIG. 2 is a diagram illustrating an example of demographic information according to an embodiment of the present invention.

FIG. 3 is a diagram illustrating an example of an optimization algorithm according to an embodiment of the present invention.

FIG. 4 is a diagram illustrating an example of a parameter indicating an influence on the probability of migration, of the distance between areas according to an embodiment of the present invention.

FIG. 5 is a diagram illustrating an example of the likelihood of gathering according to an embodiment of the present invention.

FIG. 6 is a diagram illustrating an example of the likelihood of departure according to an embodiment of the present invention.

FIG. 7 is a diagram illustrating an example of the number of migrating persons according to an embodiment of the present invention.

FIG. 8 is a diagram illustrating an example of the probability of migration according to an embodiment of the present invention.

FIG. 9 is a flowchart illustrating a migration tendency estimation process routine of a migration tendency estimation device according to according to a first embodiment of the present invention.

FIG. 10 is a schematic diagram illustrating a configuration of a migration tendency estimation device according to a second embodiment of the present invention.

FIG. 11 is a diagram illustrating an example of a total number of migrating persons according to an embodiment of the present invention.

FIG. 12 is a diagram illustrating an example of the number of migrating persons according to an embodiment of the present invention.

FIG. 13 is a flowchart illustrating a migration tendency estimation process routine of a migration tendency estimation device according to a second embodiment of the present invention.

### DESCRIPTION OF EMBODIMENTS

Hereinafter, embodiments of the present invention will be described with reference to the drawings.

### Overview of Migration Tendency Estimation Device According to an Embodiment of Present Invention

First, an overview of an embodiment of the present invention will be described.

In the present embodiment, a model in which the tendency of migration is determined by three factors: the likelihood of departure from each area, the likelihood of gathering of persons in each area, and the influence of distance on the probability of migration is assumed.

By setting such an assumption, it is possible to lower the degree of freedom of a model to narrow down and output the number of migrating persons with the likelihood of migration of persons as a group taken into consideration and to perform estimation with high accuracy.

Moreover, during estimation of parameters, by maintaining the values obtained by summing the number of migrating persons rather than estimating the number of migrating persons for each pair of the starting and ending points of migration, it is possible to reduce the size of an optimization problem to be solved repeatedly. As a result, it is possible to quickly estimate the probability of migration and the number of migrating persons.

### Configuration of Migration Tendency Estimation Device According to First Embodiment of Present Invention

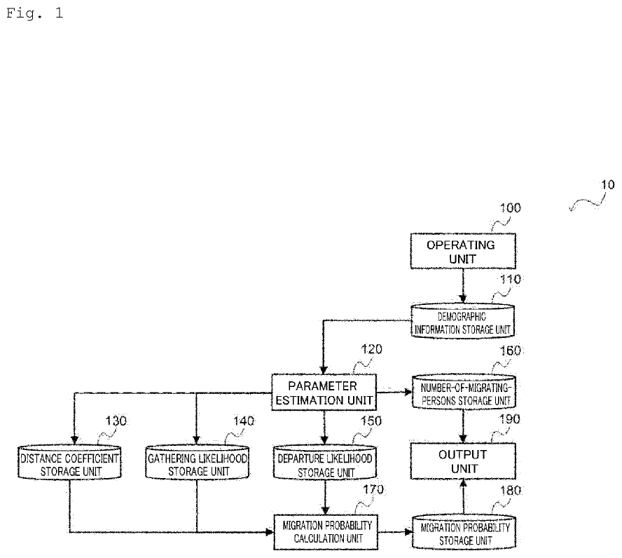

Referring to FIG. 1, a configuration of a migration tendency estimation device 10 according to an embodiment of the present invention will be described. FIG. 1 is a block diagram illustrating a configuration of the migration tendency estimation device 10 according to an embodiment of the present invention.

The migration tendency estimation device 10 is configured as a computer including a CPU, a RAM, and a ROM storing a program for executing a migration tendency estimation process routine to be described later, and is functionally configured as below.

As illustrated in FIG. 1, the migration tendency estimation device 10 according to the present embodiment includes an operating unit 100, a demographic information storage unit 110, a parameter estimation unit 120, a distance coefficient storage unit 130, a gathering likelihood storage unit 140, a departure likelihood storage unit 150, a number-of-migrating-persons storage unit 160, a migration probability calculation unit 170, a migration probability storage unit 180, and an output unit 190.

The operating unit 100 receives an operation related to demographic information.

Specifically, the operating unit 100 receives various operations on the demographic information storage unit 110. Various operations include, for example, an operation of inputting and registering demographic information to the demographic information storage unit 110 and an operation of correcting and deleting demographic information stored in the demographic information storage unit 110.

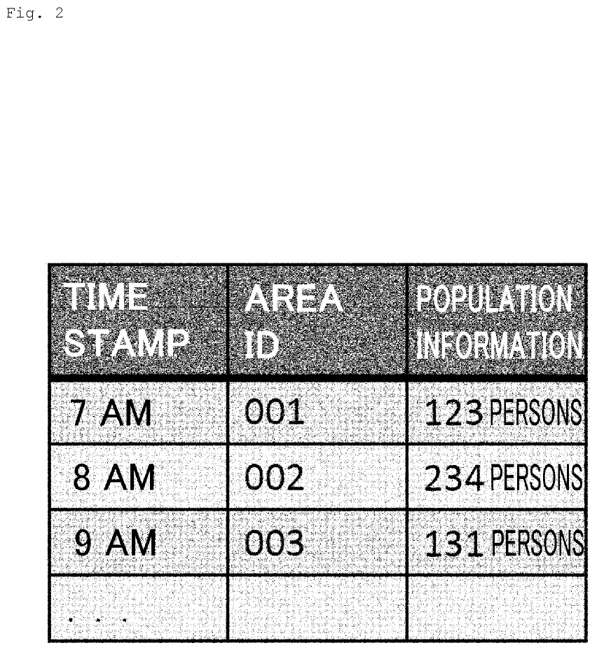

Here, demographic information is population information of each area at each time point (time step). FIG. 2 illustrates an example of demographic information. Moreover, a time step is represented by a predetermined time interval and is a time point of an interval of 1 hour such as 7 AM, 8 AM, 9 AM, . . . , and the like, for example.

An area is a predetermined region on a map, and for example, a geographic space partitioned into 5-km square grids can be adopted. At time point t, a population of area i is represented by Nₜᵢ.

The demographic information storage unit 110 stores demographic information.

The parameter estimation unit 120 estimates a first parameter πᵢ indicating the likelihood of departure from the area i to another area and a second parameter sᵢ indicating the likelihood of gathering of persons in the area i for each of a plurality of areas, a third parameter β indicating the influence on a probability of migration θᵢⱼ, of the distance between the areas, and the number of migrating persons Mₜᵢⱼ from the area i to another area j on the basis of the demographic information so as to optimize an objective function indicating the likelihood of the number of migrating persons Mₜᵢⱼ determined using π, sᵢ, β, and the demographic information.

Specifically, first, the parameter estimation unit 120 assumes that, when the probability of migration from the area i to the area j is θᵢⱼ, the number of persons

Mₜᵢ={Mₜᵢⱼ|j∈v}

migrating from the area i at time point t is generated with a probability represented by Formula (1) below using the probability of migration

θᵢ={θᵢⱼ|j∈Γᵢ}

from the area i.

$$\begin{matrix}[ Formula 1 ] & \\ P ( {M}_{ti} \vert {N}_{ti} , {θ}_{i} ) = \frac{{N}_{ti} !}{{\prod }_{j ∈ {Γ}_{i}}^{ } {M}_{tij} !} {\prod }_{j ∈ {Γ}_{i}}^{ } {θ}_{ij}^{{M}_{tij}} & ( 1 )\end{matrix}$$

Here, V is a set of all areas and an undirected graph indicating an adjacency between areas is G=(V:E). Moreover, Γᵢ is a set of migration candidate areas from the area i.

Therefore, when the followings are given,

N={Nₜᵢ|t=0, . . . ,T−1,i∈V}

and

θ={θᵢ|i∈V},

the likelihood function of the following is represented by Formula (2) below.

$$\begin{matrix}M = \{ {M}_{ti} \vert t = 0 , … , T - 2 , i ∈ V \} & \\ [ Formula 2 ] & \\ P ( M \vert N , θ ) = {\prod }_{t = 0}^{T - 2} {\prod }_{i ∈ V} ( \frac{{N}_{ti} !}{{\prod }_{j ∈ {Γ}_{i}}^{ } {M}_{tij} !} {\prod }_{j ∈ {Γ}_{i}}^{ } {θ}_{ij}^{{M}_{tij}} ) & ( 2 )\end{matrix}$$

Here, T is a largest value of a time step. That is, the time step is t=0, . . . , and T−1. Moreover, the following is a population in the area i at time point t.

Nₜᵢ(t=0, . . . ,T−1,i∈V)

Moreover, the following is the number of persons having migrated from the area i to the area j from time point t to time point t+1.

Mₜᵢⱼ(t=0,1, . . . ,T−2,i,j∈V)

When the logarithm of Formula (2) is taken, Formula (3) below is obtained.

$$\begin{matrix} [ Formula 3 ] & \\ \begin{matrix}log P ( M \vert {N}_{1} θ ) = {\sum }_{t = 0}^{T - 2} {\sum }_{i ∈ V} ( log {N}_{ti} ! - {\sum }_{j ∈ {Γ}_{i}}^{ } log {M}_{tij} ! + {\sum }_{j ∈ {Γ}_{i}}^{ } {M}_{tij} log {θ}_{ij} ) \\ \approx {\sum }_{t = 0}^{T - 2} {\sum }_{i ∈ V} ( {N}_{ti } {logN}_{ti} - {N}_{ti} - {\sum }_{j ∈ {Γ}_{i}}^{ } ( {M}_{tij} {logM}_{tij} - \\ {M}_{tij} ) + {\sum }_{j ∈ {Γ}_{i}}^{ } {M}_{tij} log {θ}_{ij} ) \\ \approx {\sum }_{t = 0}^{T - 2} {\sum }_{i ∈ V} {\sum }_{j ∈ {Γ}_{i}}^{ } ( log {θ}_{ij} {M}_{tij} + {M}_{tij} - {M}_{tij} {logM}_{tij} ) + const .\end{matrix} & ( 3 )\end{matrix}$$

In this case, the following Stirling's approximation is used as intermediate deformation.

log n!≈n log n−n

Moreover, parts that do not depend on variables to be estimated are omitted by regarding the same as constants.

Moreover, Formulas (4) and (5) below which are constraints indicating the law of conservation of the number of persons are satisfied.

$$\begin{matrix}[ Formula 4 ] & \\ {N}_{ti} = {\sum }_{j ∈ {Γ}_{i}}^{ } {M}_{tij} ( t = 0 , 1 , … , T - 2 ) & ( 4 ) \\ {N}_{t + 1 , i} = {\sum }_{j ∈ {Γ}_{i}}^{ } {M}_{tji} ( t = 1 , 2 , … , T - 1 ) & ( 5 )\end{matrix}$$

Here, it is assumed that the probability of migration θᵢⱼ can be approximated from the three factors including the likelihood of departure from each area, the likelihood of gathering of persons in each area, and the influence on the probability of migration θᵢⱼ of distance. For example, it is assumed that the probability of migration θᵢⱼ can be written in the form of Formula (6) below.

$$\begin{matrix} [ Formula 5 ] & \\ {θ}_{ij} = \{ \begin{matrix}1 - {π}_{i} & ( i = j ) \\ {π}_{i} \cdot \frac{{s}_{j} \cdot exp ( - β \cdot d ( i , j ) )}{{\sum }_{\text{?}} {s}_{k} \cdot exp ( - β \cdot d ( i , k ) )} & ( j \neq i , j ∈ {Γ}_{i} ) \\ 0 & ( otherwise )\end{matrix} & ( 6 ) \\ \text{?} \text{indicates text missing or illegible when filed} & \end{matrix}$$

However, Formula (7) below is satisfied.

π={πᵢ|i∈V} [Formula 6]

s={sᵢ|i∈V} (7)

Here, πᵢ is a value indicating the likelihood of departure from the area i and satisfies the following relation.

0≤πᵢ≤1

Moreover, sᵢ is a score indicating the likelihood of gathering of persons in the area i and satisfies the following relation.

sᵢ≥0

sᵢ has a degree of freedom with respect to a constant multiple.

Moreover, β is a parameter indicating the influence on the probability of migration θᵢⱼ of distance and satisfies the following relation.

β≥0

Moreover, d(i, j) is the distance between the area i and the area j.

When Formula (6) is substituted into Formula (3) representing a logarithmic likelihood, the following logarithmic likelihood function is obtained.

$$[ Formula 7 ]$$

$$\begin{matrix}log P ( M \vert N , π , s , β ) = {\sum }_{t = 0}^{T - 2} {\sum }_{i ∈ V} log ( 1 - {π}_{i} ) M \text{?} \\ + {\sum }_{t = 0}^{T - 2} {\sum }_{i ∈ V} {\sum }_{j ∈ {Γ}_{i} \backslash \{ i \}} \{ log {π}_{i} + log {s}_{j} - β \cdot d ( i , j ) - \\ log ( {\sum }_{k ∈ {Γ}_{i} \backslash ( i )}^{ } {s}_{k} exp ( - β \cdot d ( i , k ) ) ) \} {M}_{tij} \\ + {\sum }_{t = 0}^{T - 2} {\sum }_{i ∈ V} {\sum }_{j ∈ {Γ}_{i}}^{ } ( {M}_{tij} - {M}_{itj} log {M}_{tij} ) + const .\end{matrix}$$

$$\text{?} \text{indicates text missing or illegible when filed}$$

Using this logarithmic likelihood function,
M,π,s,β
   are estimated.

That is, an optimization problem to be solved is represented by Formulas (8a) to (8d) below.

$$[ Formula 8 ]$$

$$\begin{matrix}maximize ℒ ( M , π , s , β ) , & ( 8 a ) \\ subject to {N}_{ti} = {\sum }_{j ∈ {Γ}_{i}} {M}_{tij} ( t = 0 , 1 , … , T - 2 ) , & ( 8 b ) \\ {N}_{t + 1 , i} = {\sum }_{j ∈ {Γ}_{i}} {M}_{tji} ( t = 0 , 2 , … , T - 2 ) & ( 8 c ) \\ M \geq 0 & ( 8 d )\end{matrix}$$

However, objective functions are set as Formulas (9) and (10) as below.

$$[ Formula 9 ]$$

$$\begin{matrix}ℒ ( M , π , s , β ) := {\sum }_{t = 0}^{T - 2} {\sum }_{i ∈ V} {\sum }_{j ∈ {Γ}_{i}} ( log {θ}_{ij} {M}_{tij} + {M}_{tij} - {M}_{tsj} log {M}_{tij} ) & ( 9 ) \\ = {\sum }_{t = 0}^{T - 2} {\sum }_{i ∈ V} log ( 1 - {π}_{i} ) {M}_{tii} & \\ + {\sum }_{t = 0}^{T - 2} {\sum }_{i ∈ V} {\sum }_{j ∈ {Γ}_{i} \backslash \{ i \}} \{ log {π}_{i} + log {s}_{j} - β \cdot d ( i , j ) - & \\ log ( {\sum }_{k ∈ {Γ}_{i} \backslash ( i )}^{ } {s}_{k} exp ( - β \cdot d ( i , k ) ) ) \} {M}_{tij} & \\ + {\sum }_{t = 0}^{T - 2} {\sum }_{i ∈ V} {\sum }_{j ∈ {Γ}_{i}} ( {M}_{tij} - {M}_{tij} log {M}_{tij} ) & ( 10 )\end{matrix}$$

Here, by taking noise present in observation into consideration, an objective function is set as (11) below, and solving an optimization problem of Formula (12) below will be considered.

$$\begin{matrix}[ Formula 10 ] & \\ {ℒ}^{′} ( M , π , s , β ) = ℒ ( M , π , s , β ) - \frac{λ}{2} {\sum }_{t = 0}^{T - 2} {\vert {N}_{ti} - {\sum }_{j ∈ {Γ}_{i}} {M}_{tij} \vert}^{2} - \frac{λ}{2} {\sum }_{t = 0}^{T - 2} {\vert {N}_{t + 1 , i} - {\sum }_{j ∈ {Γ}_{i}} {M}_{tji} \vert}^{2} & ( 11 ) \\ [ Formula 11 ] & \\ maximize {ℒ}^{′} ( M , π , s , β ) , & ( 12 a ) \\ subject to M \geq 0 & ( 12 b )\end{matrix}$$

Here, λ is a parameter for controlling how strong constraints are to be kept.

Subsequently, the parameter estimation unit 120 optimizes
M.

Since an objective function

[symbol]

is concave with respect to
M,
   a global optimal solution can be calculated using a convex optimization method such as an L-BFGS-B method (Reference 1), for example.
[Reference 1] R. H. Byrd, P. Lu, J. Nocedal, and C. Zhu, A Limited Memory Algorithm for Bound Constrained Optimization, SIAM Journal on Scientic Computing, vol. 16, 1995, pp. 1190-1208.

Subsequently, the parameter estimation unit 120 optimizes
π
   When the objective function [symbol]
   is arranged with respect to
π
   the following Formula is obtained.

$${ℒ}^{′} = {\sum }_{i ∈ V} [ log ( 1 - {π}_{i} ) \cdot ( {\sum }_{t = 0}^{T - 2} {M}_{tii} ) + log {π}_{i} \cdot ( {\sum }_{t = 0}^{T - 2} {\sum }_{j ∈ {Γ}_{i} \backslash \{ i \}} {M}_{tij} ) ] \qquad [ Formula 12 ]$$

However, parts that do not depend on
π
   are omitted.
π*
   that optimizes this can be described in a closed form like Formula (13) below by the method of Lagrange multipliers.

$$\begin{matrix}[ Formula 13 ] & \\ {π}_{i}^{*} = \frac{{\sum }_{t = 0}^{T - 2} {\sum }_{j ∈ {Γ}_{i} \backslash \{ i \}} {M}_{tij}}{{\sum }_{t = 0}^{T - 2} {\sum }_{j ∈ {Γ}_{i}} {M}_{tij}} & ( 13 )\end{matrix}$$

Subsequently, the parameter estimation unit 120 optimizes
s
   and β. When the objective function [symbol]
   is arranged with respect to
s
   and β, Formula (14) below is obtained.

$$\begin{matrix}[ Formula 14 ] & \\ {ℒ}^{′} = {\sum }_{i ∈ V} [ {A}_{i} log {s}_{i} - {B}_{i} log ( {\sum }_{k ∈ {Γ}_{i} \backslash \{ i \}} {s}_{k} exp ( - β \cdot d ( i , k ) ) ) ] - β D & ( 14 )\end{matrix}$$

However, as in the following Formula, parts that do not depend on
s
   and β are omitted.

$$\begin{matrix}{A}_{i} := {\sum }_{t = 0}^{T - 2} {\sum }_{j ∈ {Γ}_{i} \backslash \{ i \}} {M}_{tji} , {B}_{i} := {\sum }_{t = 0}^{T - 2} {\sum }_{j ∈ {Γ}_{i} \backslash \{ i \}} {M}_{tij} , & [ Formula 15 ] \\ D := {\sum }_{t = 0}^{T - 2} {\sum }_{i ∈ V} {\sum }_{j ∈ {Γ}_{i} \backslash \{ i \}} d ( i , j ) \cdot {M}_{tij} & \end{matrix}$$

For simplicity, the right side of Formula (14) is set as
ƒ(s,β)
   In order to maximize
ƒ(s,β)
   a scheme called a Minorization-Maximization algorithm (hereinafter, an MM algorithm) is used (Reference Document 2).
[Reference Document 2] D. R. Hunter. MM algorithms for generalized Bradley-Terry models. The Annals of Statistics, Vol. 32, No. 1, February 2003, pp. 384-406.

Here, the MM algorithm is a method of generating a group of candidate points of a solution by sequentially solving a maximization problem of an approximation function that becomes a lower bound of a function when it is difficult to directly maximize the function.

A specific application method of the MM algorithm will be described. Formula (15) below is satisfied for x, y>0.

$$\begin{matrix}[ Formula 16 ] & \\ - log x \geq 1 - log y - \frac{x}{y} & ( 15 )\end{matrix}$$

Here, as Formula (16) below, Formula (15) is applied to
i∈V
   Formula (17) below is obtained.

$$\begin{matrix} [ Formula 17 ] & \\ {x}_{i} = {\sum }_{k ∈ {Γ}_{i} \backslash \{ i \}} {s}_{k} exp ( - β \cdot d ( i , k ) ) & ( 16 ) \\ {y}_{i} = {\sum }_{k ∈ {Γ}_{i} \backslash \{ i \}} {s}_{k}^{( u )} exp ( - {β}^{( u )} \cdot d ( i , k ) ) & \\ [ Formula 18 ] & \\ f ( s , β ) \geq {\sum }_{i ∈ V} [ {A}_{i} log {s}_{i} - {C}_{i}^{( u )} {\sum }_{k ∈ Γ \text{?} \backslash \{ i \}} {s}_{k} exp ( - β \cdot d ( i , k ) ) ] - β D & ( 17 ) \\ \text{?} \text{indicates text missing or illegible when filed} & \end{matrix}$$

Here, Formula (18) below is set.

$$\begin{matrix}[ Formula 19 ] & \\ {C}_{i}^{( u )} := \frac{{B}_{i}}{{\sum }_{k ∈ {Γ}_{i} \backslash \{ i \}} {s}_{k}^{( u )} exp ( - {β}^{( u )} \cdot d ( i , k ) )} & ( 18 )\end{matrix}$$

When the right side of Formula (17) is set as
ƒ^{(u)}(s,β)
   the following relationships represented by Formulas (19) and (20) below are satisfied.

[Formula 20]

ƒ(s^{(u)},β^{(u)})=ƒ^{(u)}(s^{(u)},β^{(u)}) (19)

ƒ(s,β)≥ƒ^{(u)}(s,β)(∀s,β) (20)

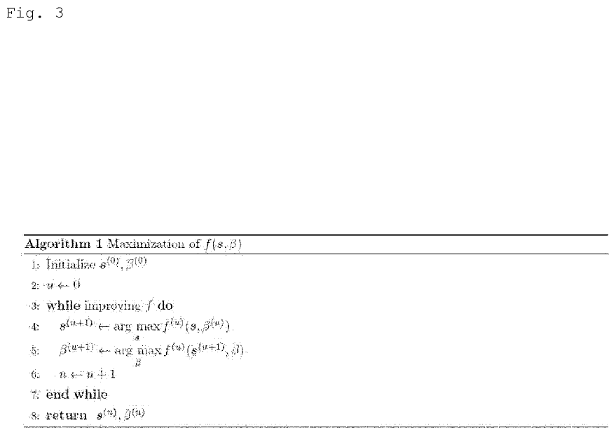

Using these notations,
ƒ(s,β)
   is maximized by Algorithm 1 illustrated in FIG. 3.

Here, in Algorithm 1, the objective function
ƒ(s,β)
   increases monotonously as can be understood from the following formula.

$$f ( {s}^{( u + 1 )} , {β}^{( u + 1 )} ) \geq {f}^{( u )} ( {s}^{( u + 1 )} , {β}^{( u + 1 )} ) ( ∵ ( 20 ) ) \geq {f}^{( u )} ( {s}^{( u + 1 )} , {β}^{( u )} ) \geq {f}^{( u )} ( {s}^{( u )} , {β}^{( u )} ) = f ( {s}^{( u )} , {β}^{( u )} ) ( ∵ ( 19 ) ) \qquad [ Formula 21 ]$$

Here, in Algorithm 1, update formulas of
s
   and β are derived.

First, Formula (21) below is satisfied for the following formula:

$${s}^{( u + 1 )} ← {arg max}_{s} {f}^{( u )} ( s , {β}^{( u )} ) , {s}^{( u + 1 )}$$

can be obtained in a closed form.

$$\begin{matrix}[ Formula 22 ] & \\ \frac{\partial {f}^{( u )} ( s , {β}^{( u )} )}{\partial {s}_{i}} = 0 ⇔ {s}_{i} \frac{{A}_{i}}{{\sum }_{k ∈ {Γ}_{i} \backslash \{ i \}} {C}_{k}^{( u )} exp ( - {β}^{( u )} \cdot d ( k , i ) )} & ( 21 )\end{matrix}$$

Next, the following formula will be considered.

$${β}^{( u + 1 )} ← {arg max}_{β} {f}^{( u )} ( {s}^{( u + 1 )} , β )$$

It can be ascertained by calculation that the following relation is satisfied for

$$∀ β ∈ \cdot \frac{{\partial }^{2} {f}^{( u )} ( {s}^{( u + 1 )} , β )}{\partial {β}^{2}} < 0$$

That is, f^{(u)} is a concave function for β.

Therefore, when β^{(u+1)} is to be calculated, a maximization problem of a concave function with one variable related to β may be solved and can be efficiently calculated by the golden section search, the Newton's method, and the like.

These operations are repeated until it settles whereby
s
   and β are optimized.

The parameter estimation unit 120 estimates the values obtained by optimization as
M,π,s,β,
   and stores β in the distance coefficient storage unit 130, stores
s
   in the gathering likelihood storage unit 140, stores
π
   in the departure likelihood storage unit 150, and stores
M
   in the number-of-migrating-persons storage unit 160.

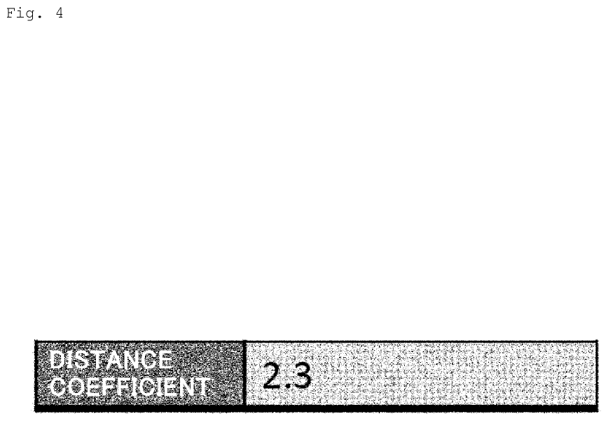

The distance coefficient storage unit 130 stores the third parameter β indicating the influence on the probability of migration θᵢⱼ of the distance between the area i and the other area i optimized by the parameter estimation unit 120 (FIG. 4). FIG. 4 is a specific example of β.

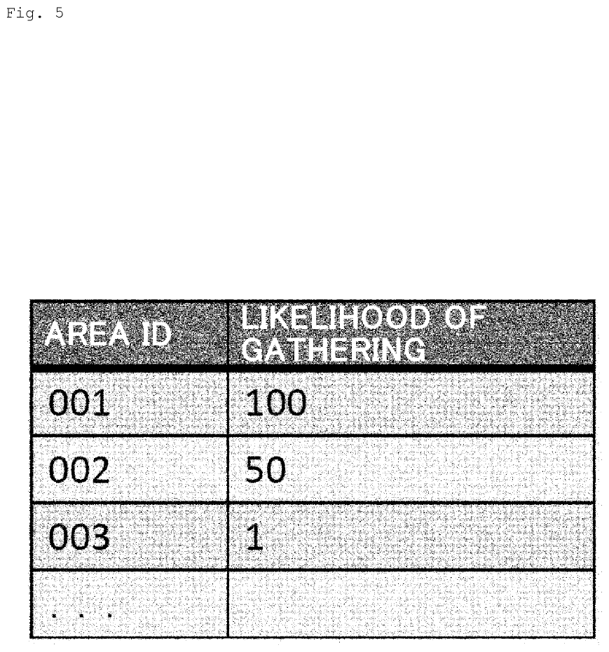

The gathering likelihood storage unit 140 stores the second parameter sᵢ indicating the likelihood of gathering of persons in the area i optimized by the parameter estimation unit 120 (FIG. 5). FIG. 5 is a diagram illustrating an example of sᵢ.

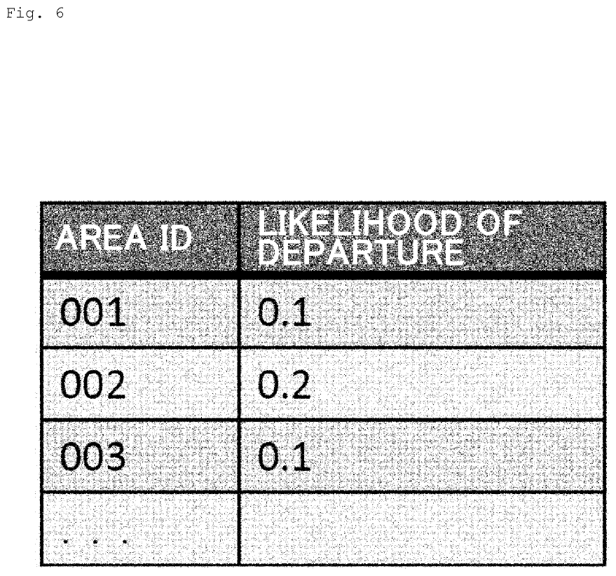

The departure likelihood storage unit 150 stores the first parameter πᵢ indicating the likelihood of departure from the area i to the other area optimized by the parameter estimation unit 120 (FIG. 6). FIG. 6 is a diagram illustrating an example of πᵢ.

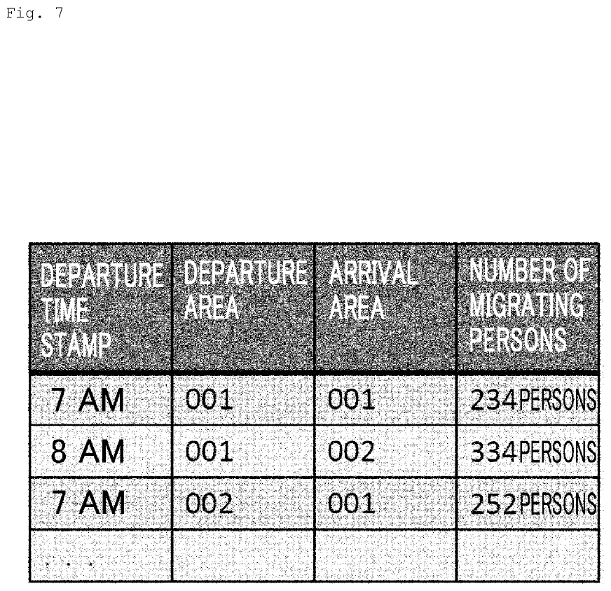

The number-of-migrating-persons storage unit 160 stores the number of migrating persons Mₜᵢⱼ from the area i to the other area j optimized by the parameter estimation unit 120 (FIG. 7). FIG. 7 is a diagram illustrating an example of the number of migrating persons Mₜᵢⱼ.

The migration probability calculation unit 170 calculates the probability of migration θᵢⱼ from the area i to each of the other areas j for each of a plurality of areas on the basis of πᵢ stored in the departure likelihood storage unit 150, sᵢ stored in the gathering likelihood storage unit 140, and β stored in the distance coefficient storage unit 130.

Specifically, the migration probability calculation unit 170 calculates the probability of migration θᵢⱼ by Formula (22) below.

$$\begin{matrix}[ Formula 23 ] & \\ {θ}_{i , j} = \{ \begin{matrix}1 - {π}_{i} & ( i = j ) \\ {π}_{i} \cdot \frac{{s}_{i} - exp ( - β \cdot d ( i , j ) )}{{\sum }_{k ∈ {Γ}_{i} \backslash \{ i \}} {s}_{k} \cdot exp ( - β \cdot d ( i , k ) )} & ( j \neq i , j ∈ {Γ}_{i} ) \\ 0 & ( otherwise )\end{matrix} & ( 22 )\end{matrix}$$

The migration probability calculation unit 170 stores the calculated probability of migration θᵢⱼ in the migration probability storage unit 180.

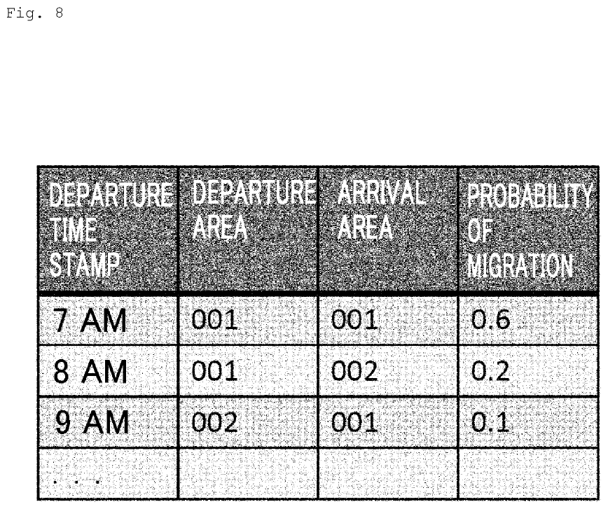

The migration probability storage unit 180 stores the probability of migration θᵢⱼ calculated by the migration probability calculation unit 170 (FIG. 8). FIG. 8 is a diagram illustrating an example of the probability of migration θᵢⱼ.

The output unit 190 reads and outputs the number of migrating persons Mₜᵢⱼ from the area i to the other area j in a plurality of areas at each time step stored in the number-of-migrating-persons storage unit 160 and the probability of migration θᵢⱼ from the area i to the other area j stored in the migration probability storage unit 180.

### Operation of Migration Tendency Estimation Device According to First Embodiment of Present Invention

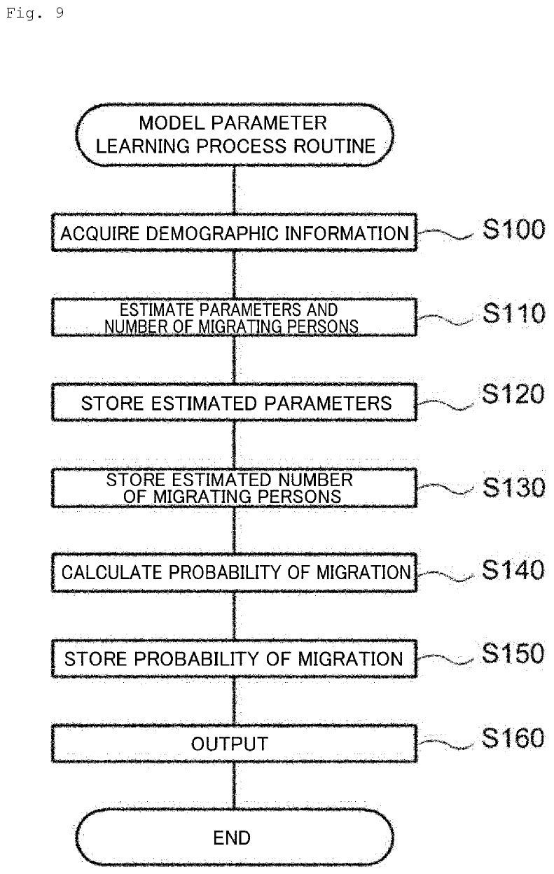

FIG. 9 is a flowchart illustrating a migration tendency estimation process routine according to an embodiment of the present invention.

When a migration tendency estimation process is executed, a migration tendency estimation process routine illustrated in FIG. 9 is executed by the migration tendency estimation device 10.

First, in step S100, the parameter estimation unit 120 acquires demographic information from the demographic information storage unit 110.

In step S110, the parameter estimation unit 120 estimates a first parameter πᵢ indicating the likelihood of departure from the area i to another area and a second parameter sᵢ indicating the likelihood of gathering of persons in the area i for each of a plurality of areas, a third parameter β indicating the influence on a probability of migration θᵢⱼ, of the distance between the areas, and the number of migrating persons Mₜᵢⱼ from the area i to another area j on the basis of the demographic information so as to optimize an objective function indicating the likelihood of the number of migrating persons Mₜᵢⱼ determined using π, sᵢ, β, and the demographic information.

In step S120, the parameter estimation unit 120 stores β,
s
   and
π
   estimated in step S110 in the distance coefficient storage unit 130, the gathering likelihood storage unit 140, and the departure likelihood storage unit 150, respectively.

In step S130, the parameter estimation unit 120 stores
M
   estimated in step S110 in the number-of-migrating-persons storage unit 160.

In step S140, the migration probability calculation unit 170 calculates the probability of migration θᵢⱼ from the area i to each of the other areas j for each of a plurality of areas on the basis of πᵢ stored in the departure likelihood storage unit 150, sᵢ stored in the gathering likelihood storage unit 140, and β stored in the distance coefficient storage unit 130.

In step S150, the migration probability calculation unit 170 stores the probability of migration θᵢⱼ calculated in step S140 in the migration probability storage unit 180.

In step S160, the output unit 190 outputs the number of migrating persons Mₜᵢⱼ and the probability of migration θᵢⱼ.

As described above, according to the migration tendency estimation device 10 according to the present embodiment, the first parameter indicating the likelihood of departure from an area to another area and the second parameter indicating the likelihood of gathering of persons to the area for each of a plurality of areas, and the third parameter indicating the influence on the probability of migration of the distance between areas, and the number of migrating persons from the area to each of the other areas for each of the plurality of areas are estimated on the basis of the demographic information, and the probability of migration from the area to each of the other areas is calculated for each of the plurality of areas on the basis of the first parameter, the second parameter, and the third parameter. Therefore, even when migration to an area other than adjacent areas is taken into consideration, it is possible to estimate the probability of migration and the number of migrating persons with high accuracy and a small amount of calculation.

### Principle of Migration Tendency Estimation Device According to Second Embodiment of Present Invention

In a second embodiment of the present invention, during estimation of parameters, by maintaining the values obtained by summing the number of migrating persons rather than estimating the number of migrating persons for each pair of the starting and ending points of migration, it is possible to reduce the size of an optimization problem to be solved repeatedly.

In the present embodiment, a first parameter πᵢ indicating the likelihood of departure from the area i to another area and a second parameter sᵢ indicating the likelihood of gathering of persons in the area i for each of a plurality of areas, a third parameter β indicating the influence on a probability of migration θᵢⱼ, of the distance between the areas, and the total number of migrating persons obtained by summing the numbers of migrating persons for respective positional relationships between areas are estimated on the basis of the demographic information so as to optimize an objective function indicating the likelihood of the total number of migrating persons determined using π, sᵢ, β, and the demographic information.

A set of all areas Γᵢ_{^{δ}} at a distance δ from the area i is defined as below.

δ_{iδ}:={j|j∈Γᵢ,d(i,j)=δ}

Moreover, a set of all possible values for the distance between two areas is defined as below.

Δ:={r∈ [symbol] |∃(i,j)∈E,d(i,j)=r}

Moreover, a set in which 0 is excluded from A is defined as below.

Δ⁻:=Δ\{0}

The sum of the numbers of migrating persons for respective positional relationships between areas is defined as a total number of migrating persons and is set as Formulas (23) to (26) below.

$$\begin{matrix}[ Formula 24 ] & \\ {A}_{t i δ} := {\sum }_{j ∈ {Γ}_{i δ}} {M}_{t j i} & ( 23 ) \\ {A}_{i δ} := {\sum }_{t = 0}^{T - 2} {\sum }_{j ∈ {Γ}_{i δ}} {M}_{t j i} & ( 24 ) \\ {B}_{t i δ} := {\sum }_{j ∈ {Γ}_{i δ}} {M}_{t i j} & ( 25 ) \\ {B}_{i δ} := {\sum }_{t = 0}^{T - 2} {\sum }_{j ∈ {Γ}_{i δ}} {M}_{t i j} & ( 26 )\end{matrix}$$

In this case, the relationships of Formulas (27) to (30) below are satisfied.

$$\begin{matrix}[ Formula 25 ] & \\ {A}_{i δ} = {\sum }_{t = 0}^{T - 2} {A}_{t i δ} , & ( 27 ) \\ {A}_{i} = {\sum }_{δ ∈ {Δ}^{-}} {A}_{i δ} = {\sum }_{t = 0}^{T - 2} {\sum }_{δ ∈ {Δ}^{-}} {A}_{t i δ} , & ( 28 ) \\ {B}_{i δ} = {\sum }_{t = 0}^{T - 2} {B}_{t i δ} , & ( 29 ) \\ {B}_{i} = {\sum }_{δ ∈ {Δ}^{-}} {B}_{i δ} = {\sum }_{t = 0}^{T - 2} {\sum }_{δ ∈ {Δ}^{-}} {B}_{t i δ} . & ( 30 )\end{matrix}$$

Since Formula (31) below is satisfied, Formula (13) can be replaced with Formula (32) below.

$$\begin{matrix}[ Formula 26 ] & \\ D = {\sum }_{i ∈ V} {\sum }_{δ ∈ Δ} δ \cdot {A}_{i δ} & ( 31 ) \\ [ Formula 27 ] & \\ {π}_{i}^{*} = \frac{{\sum }_{t = 0}^{T - 2} {B}_{t i}}{{\sum }_{t = 0}^{T - 2} {B}_{t i} + {\sum }_{t = 0}^{T - 2} {M}_{t i i}} , & ( 32 )\end{matrix}$$

Since Formula (31) is satisfied, Formula (14) can be replaced with Formula (33) below.

$$\begin{matrix} [ Formula 28 ] & \\ f ( s , β ) := {\sum }_{i ∈ V} [ ( {\sum }_{t = 0}^{T - 2} {\sum }_{δ ∈ {Δ}^{-}} {A}_{t i δ} ) log {s}_{i} - ( {\sum }_{t = 0}^{T - 2} {B}_{t i } ) \cdot log ( {\sum }_{k ∈ {Γ}_{i} \backslash \{ i \}} {s}_{k} exp ( - β \cdot d ( i , k ) ) ) ] - β \cdot {\sum }_{t = 0}^{T - 2} {\sum }_{i ∈ V} {\sum }_{δ ∈ {Δ}^{-}} δ \cdot {A}_{t i δ} . & ( 33 )\end{matrix}$$

From Formulas (32) and (33), it can be understood that Mₜᵢⱼ(t=0, 1, . . . , T−2,(i,j)∈E) is not necessarily required, but Aₜᵢ_{^{δ}}, Bₜᵢ, and Mₜᵢᵢ(t=0, 1, . . . ,T−2,i∈V,δ∈Δ⁻)

are sufficient for updating
π,s,β.

By utilizing this nature to solve an optimization problem related to Aₜᵢ_{^{δ}}, Bₜᵢ, and Mₜᵢᵢ rather than the optimization problem related to Mₜᵢⱼ, it is possible to estimate π, sᵢ, β, and the total number of migrating persons.

For example, areas obtained by partitioning a square geological space in a grid form are formed and the following distance is used as the distance between grids.
L₂_{^{−}}
   With Mₜᵢⱼ, the number of variables of a convex optimization problem that should be solved is approximately

O(T·|V|₂).

However, with Aₜᵢ_{^{δ}}, Bₜᵢ, and Mₜᵢᵢ, the number of variables of a convex optical communication controller that should be solved is approximately

O(T·|V|^{3/2}).

Here, an objective function and the constraints of the optimization parts of Aₜᵢ_{^{δ}}, Bₜᵢ, and Mₜᵢᵢ are problems. When variables have such a form as Aₜᵢ_{^{δ}}, Bₜᵢ, and Mₜᵢᵢ, there is a problem that it is not possible to write down the likelihood function accurately. Therefore, this problem is solved by approximating the likelihood function.

First, independency of Aₜᵢ_{^{δ}}, Bₜᵢ, and Mₜᵢᵢ is assumed.

Like Formula (23), the followings are set.

A_{tiδ}:=Σ_{j∈Γ}_{_{iδ}}Mₜⱼᵢ

Mₜⱼᵢ˜Bin(Nₜⱼ,θⱼᵢ)

Here, Bin(Nₜⱼ, θⱼᵢ) is approximated by a Poisson distribution Po (Nₜⱼ·θⱼᵢ). In this case, it can be thought that due to the reproducibility of the Poisson distribution, Aₜᵢ_{^{δ}} approximately follows the following Poisson distribution.

Po(Σ_{j∈Γ}_{_{iδ}}Nₜⱼ·θⱼᵢ)

In this case, when the following is set, Formula (34) below is obtained.

$$\begin{matrix}{μ}_{i δ} := {\sum }_{j ∈ {Γ}_{i δ}} {N}_{t j} \cdot {θ}_{j i} & \\ [ Formula 29 ] & \\ P ( {A}_{t i δ} ) \approx \frac{{μ}_{i δ}^{{A}_{t i δ}} {e}^{- {μ}_{i δ}}}{{A}_{t i δ} !} & ( 34 )\end{matrix}$$

Similarly, for Bₜᵢ and Mₜᵢᵢ, Formulas (35) and (36) below are obtained.

$$\begin{matrix}[ Formula 30 ] & \\ P ( {B}_{t i} ) \approx \frac{{( {N}_{t i} {π}_{i} )}^{{B}_{t i}} {e}^{- {N}_{t i} {π}_{i}}}{{B}_{t i} !} , & ( 35 ) \\ P ( {M}_{t i i} ) \approx \frac{{\{ {N}_{t i} ( 1 - {π}_{i} ) \}}^{{M}_{t i i}} {e}^{- {N}_{t i} ( 1 - {π}_{i} )}}{{M}_{t i i} !} & ( 36 )\end{matrix}$$

Therefore, the likelihood function becomes Formula (37) below.

$$\begin{matrix}[ Formula 31 ] & \\ ( {\prod }_{t = 0}^{T - 2} {\prod }_{i ∈ V} {\prod }_{δ ∈ {Δ}^{-}} P ( {A}_{t i δ} ) ) ( {\prod }_{t = 0}^{T - 2} {\prod }_{i ∈ V} P ( {B}_{t i} ) ) ( {\prod }_{t = 0}^{T - 2} {\prod }_{i ∈ V} P ( {M}_{t i i} ) ) & ( 37 )\end{matrix}$$

When the logarithm of Formula (37) is taken, Formulas (38) to (41) below are obtained.

$$\begin{matrix} [ Formula 32 ] & \\ ( {\sum }_{t = 0}^{T - 2} {\sum }_{i ∈ V} {\sum }_{δ ∈ {Δ}^{-}} P ( {A}_{t i δ} ) ) + ( {\sum }_{t = 0}^{T - 2} {\sum }_{i ∈ V} P ( {B}_{t i} ) ) + ( {\sum }_{t = 0}^{T - 2} {\sum }_{i ∈ V} P ( {M}_{t i i} ) ) \approx & ( 38 ) \\ {\sum }_{t = 0}^{T - 2} {\sum }_{i ∈ V} {\sum }_{δ ∈ {Δ}^{-}} \{ {A}_{t i δ} \cdot ( log {μ}_{i δ} + 1 ) - {A}_{t i δ} log {A}_{t i δ} \} + & ( 39 ) \\ {\sum }_{t = 0}^{T - 2} {\sum }_{i ∈ V} \{ {B}_{t i} \cdot ( log ( {N}_{t i} {π}_{i} ) + 1 ) - {B}_{t i} log {B}_{t i} \} + & ( 40 ) \\ {\sum }_{t = 0}^{T - 2} {\sum }_{i ∈ V} \{ {M}_{t i i} ( log ( {N}_{t i} ( 1 - {π}_{i} ) ) + 1 ) - {M}_{t i i} log {M}_{t i i} \} + const . & ( 41 )\end{matrix}$$

This is solved under Formulas (42) and (43) below which are constraints indicating the law of conservation of the number of persons.

$$\begin{matrix}[ Formula 33 ] & \\ {N}_{t , i} = {\sum }_{δ ∈ {Δ}^{-}} {A}_{t i δ} + {M}_{t i i} ( t = 0 , 1 , … , T - 2 , i ∈ V ) & ( 42 ) \\ {N}_{t + 1 , i} = {B}_{t i} + {M}_{t i i} ( t = 0 , 1 , … , T - 2 , i ∈ V ) & ( 43 )\end{matrix}$$

As a result, the objective function is set as Formulas (44) to (46) below, and Formula (47) below may be solved for t=0, 1, . . . , and T−2.

$$\begin{matrix}[ Formula 34 ] & \\ \begin{matrix}{ℒ}_{i}^{″} = {\sum }_{i ∈ V} {\sum }_{δ ∈ {Δ}^{-}} \{ {A}_{t i δ} \cdot ( log {μ}_{i δ} + 1 ) - {A}_{t i δ} log {A}_{t i δ} \} + & ( 44 ) \\ {\sum }_{i ∈ V} \{ {B}_{t i} \cdot ( log ( {N}_{t i} {π}_{i} ) + 1 ) - {B}_{t i} log {B}_{t i} \} + & ( 45 ) \\ {\sum }_{i ∈ V} \{ {M}_{t i i} ( log ( {N}_{t i} ( 1 - {π}_{i} ) ) + 1 ) - {M}_{t i i} log {M}_{t i i} \} & ( 46 )\end{matrix} & \\ [ Formula 35 ] & \\ maximize {ℒ}_{i}^{″} , & ( 47 a ) \\ subject to {N}_{t , i} = {\sum }_{δ ∈ {Δ}^{-}} {A}_{t i δ} + {M}_{t i i} ( i ∈ V ) , & ( 47 b ) \\ {N}_{t + 1 , i} = {B}_{t i} + {M}_{t i i} ( i ∈ V ) , & ( 47 c ) \\ {A}_{t i δ} \geq 0 ( t = 0 , 1 , … , T - 2 , i ∈ V , δ ∈ {Δ}^{-} ) & ( 47 d ) \\ {B}_{t i δ} \geq 0 ( t = 0 , 1 , … , T - 2 , i ∈ V ) & ( 47 e ) \\ {M}_{t i i} \geq 0 ( t = 0 , 1 , … , T - 2 , i ∈ V ) & ( 47 f )\end{matrix}$$

This optimization problem can be solved by the L-BFGS-B method or the like by adding equality constraints to the objective function as a penalty.

As a whole, a process of solving the optimization problem (Formula (47)) to update Aₜᵢ_{^{δ}}, Bₜᵢ, and Mₜᵢᵢ and update
π
   according to Formula (32) and maximizing Formula (33) to update
s
   and β is repeated until it settles.

As a result, it is possible to quickly estimate the probability of migration and the number of migrating persons.

### Configuration of Migration Tendency Estimation Device According to Second Embodiment of Present Invention

A configuration of the migration tendency estimation device 20 according to the second embodiment of the present invention will be described. The same components as those of the migration tendency estimation device 10 according to the first embodiment will be denoted by the same reference numerals and the detailed description thereof will be omitted.

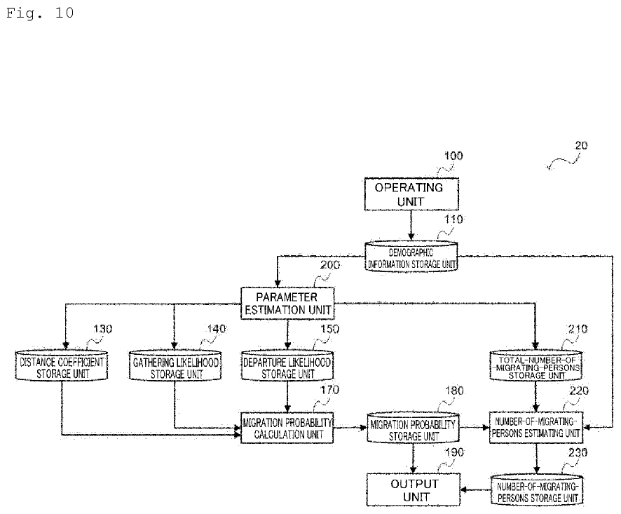

As illustrated in FIG. 10, the migration tendency estimation device 20 according to the present embodiment includes an operating unit 100, a demographic information storage unit 110, a parameter estimation unit 200, a distance coefficient storage unit 130, a gathering likelihood storage unit 140, a departure likelihood storage unit 150, a total-number-of-migrating-persons storage unit 210, a migration probability calculation unit 170, a migration probability storage unit 180, an output unit 190, a number-of-migrating-persons estimating unit 220, and a number-of-migrating-persons storage unit 230.

The parameter estimation unit 200 estimates a first parameter πᵢ indicating the likelihood of departure from the area i to another area and a second parameter sᵢ indicating the likelihood of gathering of persons in the area i for each of a plurality of areas, a third parameter β indicating the influence on a probability of migration θᵢⱼ, of the distance between the areas, and the total number of migrating persons obtained by summing the numbers of migrating persons for respective positional relationships between areas on the basis of the demographic information so as to optimize an objective function indicating the likelihood of the total number of migrating persons determined using π, sᵢ, β, and the demographic information.

Specifically, the parameter estimation unit 200 repeats a process of solving the optimization problem (Formula (47)) to update Aₜᵢ_{^{δ}}, Bₜᵢ, and Mₜᵢᵢ and update
π
   according to Formula (32) and maximizing Formula (33) to update
s
   and β until it settles.

The parameter estimation unit 200 estimates the values obtained by optimization as Aₜᵢ_{^{δ}}, Bₜᵢ, Mₜᵢᵢ,
π,s,β,
   and stores β in the distance coefficient storage unit 130,
s
   in the gathering likelihood storage unit 140,
π
   in the departure likelihood storage unit 150, and Aₜᵢ_{^{δ}}, Bₜᵢ, and Mₜᵢᵢ in the total-number-of-migrating-persons storage unit 210 as the total number of migrating persons.

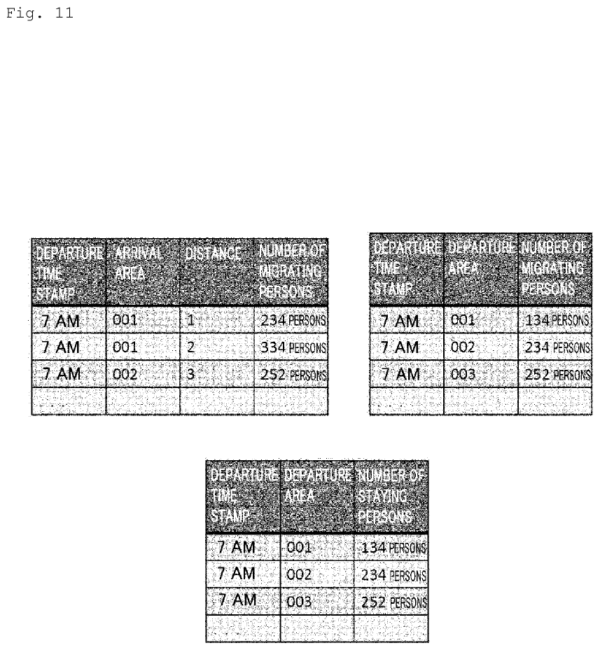

The total-number-of-migrating-persons storage unit 210 stores the total number of migrating persons Aₜᵢ_{^{δ}}, Bₜᵢ, and Mₜᵢᵢ optimized by the parameter estimation unit 200 (FIG. 11). FIG. 11 is an example of the total number of migrating persons, the top-left part of FIG. 11 is an example of Aₜᵢ_{^{δ}}, the top-right part is an example of Bₜᵢ, and the lower part is an example of Mₜᵢᵢ.

The number-of-migrating-persons estimating unit 220 estimates the number of migrating persons Mₜᵢⱼ from the area i to each of the other areas j for each of a plurality of areas on the basis of the demographic information and the probability of migration θᵢⱼ calculated by the migration probability calculation unit 170.

For example, since the probability of migration
θ
   is already given, the number-of-migrating-persons estimating unit 220 calculates the number of migrating persons
M
   by solving such a problem as an optimization problem in Formula (12). This optimization problem can be solved by the L-BFGS-B method or the like.

The number-of-migrating-persons estimating unit 220 can estimate the number of migrating persons Mₜᵢⱼ from the area i to the other area j for each of the plurality of areas on the basis of the demographic information, the total number of migrating persons estimated by the parameter estimation unit 200, and the probability of migration θᵢⱼ calculated by the migration probability calculation unit 170.

Specifically, the number-of-migrating-persons estimating unit 220 can perform faster estimation using the total number of migrating persons transmitted from the total-number-of-migrating-persons storage unit 210 as an initial value.

The number-of-migrating-persons estimating unit 220 stores the estimated number of migrating persons Mₜᵢⱼ in the number-of-migrating-persons storage unit 230.

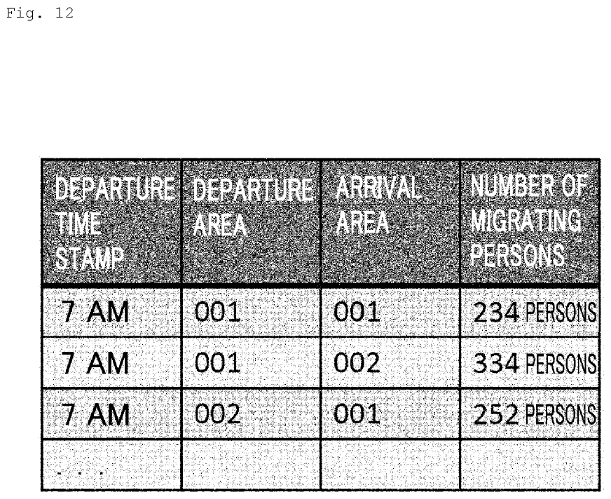

The number-of-migrating-persons storage unit 230 stores the number of migrating persons Mₜᵢⱼ from the area i to the other area j optimized by the parameter estimation unit 120 (FIG. 12). FIG. 12 is a diagram illustrating an example of the number of migrating persons Mₜᵢⱼ.

### Operation of Migration Tendency Estimation Device According to Second Embodiment of Present Invention

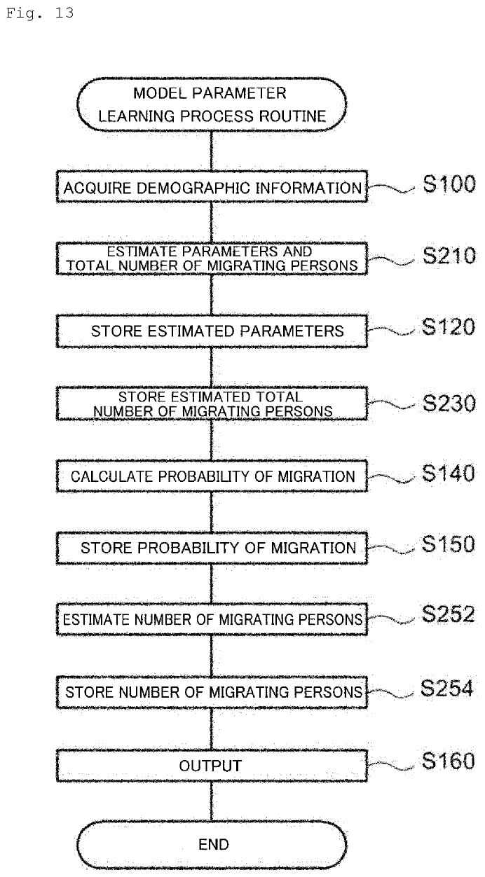

FIG. 13 is a flowchart illustrating a migration tendency estimation process routine according to the second embodiment of the present invention. The same processes as the migration tendency estimation process routine according to the first embodiment will be denoted by the same reference numerals, and the detailed description thereof will be omitted.

In step S210, the parameter estimation unit 200 estimates the first parameter πᵢ indicating the likelihood of departure from the area i to another area and the second parameter sᵢ indicating the likelihood of gathering of persons in the area i for each of a plurality of areas, the third parameter β indicating the influence on the probability of migration θᵢⱼ, of the distance between the areas, and the total number of migrating persons obtained by summing the numbers of migrating persons for respective positional relationships between areas on the basis of the demographic information so as to optimize an objective function indicating the likelihood of the total number of migrating persons determined using π, sᵢ, β, and the demographic information.

In step S230, the parameter estimation unit 200 stores the estimated Aₜᵢ_{^{δ}}, Bₜᵢ, and Mₜᵢᵢ estimated in step S210 in the total-number-of-migrating-persons storage unit 210 as the total number of migrating persons.

In step S252, the number-of-migrating-persons estimating unit 220 estimates the number of migrating persons Mₜᵢⱼ from the area i to each of the other areas j for each of a plurality of areas on the basis of the demographic information and the probability of migration θᵢⱼ calculated by the migration probability calculation unit 170.

In step S254, the number-of-migrating-persons estimating unit 220 stores the number of migrating persons Mₜᵢⱼ estimated in step S252 in the number-of-migrating-persons storage unit 230.

As described above, according to the migration tendency estimation device according to the present embodiment, the first parameter indicating the likelihood of departure from the area to another area and the second parameter indicating the likelihood of gathering of persons in the area for each of the plurality of areas, the third parameter indicating the influence on the probability of migration of the distance between areas, and the total number of migrating persons obtained by summing the numbers of migrating persons for respective positional relationships between areas are estimated on the basis of the demographic information, the probability of migration from the area to each of the other areas is calculated on the basis of the first parameter, the second parameter, and the third parameter, and the number of migrating persons from the area to each of the other areas is estimated for each of the plurality of areas on the basis of the demographic information and the probability of migration. In this way, even when migration to areas other than adjacent areas is taken into consideration, it is possible to estimate the probability of migration and the number of migrating persons with high accuracy and a small amount of calculation.

The present invention is not limited to the above-described embodiments, and various modifications and applications can be made without departing from the spirit of the present invention.

In the present specification, although an embodiment in which a program is installed in advance has been described, the program may be provided in a state of being stored in a computer-readable recording medium.

### REFERENCE SIGNS LIST

10 Migration tendency estimation device
20 Migration tendency estimation device
100 Operating unit
110 Demographic information storage unit
120 Parameter estimation unit
130 Distance coefficient storage unit
140 Gathering likelihood storage unit
150 Departure likelihood storage unit
160 Number-of-migrating-persons storage unit
170 Migration probability calculation unit
180 Migration probability storage unit
190 Output unit
200 Parameter estimation unit
210 Total-number-of-migrating-persons storage unit
220 Number-of-migrating-persons estimating unit
230 Number-of-migrating-persons storage unit

1.-7. (canceled)

8. A computer-implemented method for estimating aspects of migration of persons between areas, the method comprises:
receiving demographic information;
estimating, based on the demographic information, a first parameter, the first parameter indicating a likelihood of persons departing from a first area to one of a plurality of areas, and the plurality of areas excluding the first area;
estimating, based on the demographic information, a second parameter, the second parameter indicating a likelihood of gathering of persons in the first area from each of the plurality of areas;
estimating, based on the demographic information, a third parameter, the third parameter indicating an influence of a distance between the first area and each of the plurality of areas on a probability of migration of persons between the first area and each of the plurality of areas; and
generating, based at least on the first parameter, the second parameter, and the third parameter, a set of probabilities of migration of persons from the first area to each of the plurality of areas.

9. The computer-implemented method of claim 8, the method further comprising:
estimating, based on a combination of the first parameter, the second parameter, the third parameter, and the demographic information, a number of migrating persons from the first area to each of the plurality of areas.

10. The computer-implemented method of claim 8, wherein the demographic information comprises a plurality of a set of an area information, a number of persons in the area, and a time.

11. The computer-implemented method of claim 9, wherein a combination of the estimated values of the first parameter, the second parameter, the third parameter, and the demographic information, maximizes a likelihood of the number of migrating persons.

12. The computer-implemented method of claim 8, the method further comprising:
receiving distance information between the first area and each of the plurality of areas;
generating a plurality of groups of areas based on the plurality of areas and the received distance information;
estimating, based on the demographic information and the distance information, a set of a total numbers of migrating persons from the first area to respective groups of areas; and
estimating, based on a combination of the demographic information and the estimated set of probabilities of migration of persons from the first area to each of the plurality of areas, a number of migrating persons from the first area to each of the plurality of areas.

13. The computer-implemented method of claim 12, wherein a combination of the estimated values of the first parameter, the second parameter, the third parameter, and the demographic information, maximizes a likelihood of the number of migrating persons.

14. The computer-implemented method of claim 12, wherein an area is a geographic space partitioned in a grid of a plurality of grids, the grid having a predefined distance from adjacent grids of the plurality of grids.

15. A system for estimating aspects of migration of persons between areas, the system comprising:
a processor; and
a memory storing computer-executable instructions that when executed by the processor cause the system to:
receive demographic information;
estimate, based on the demographic information, a first parameter, the first parameter indicating a likelihood of persons departing from a first area to one of a plurality of areas, and the plurality of areas excluding the first area;
estimate, based on the demographic information, a second parameter, the second parameter indicating a likelihood of gathering of persons in the first area from each of the plurality of areas;
estimate, based on the demographic information, a third parameter, the third parameter indicating an influence of a distance between the first area and each of the plurality of areas on a probability of migration of persons between the first area and each of the plurality of areas; and
generate, based at least on the first parameter, the second parameter, and the third parameter, a set of probabilities of migration of persons from the first area to each of the plurality of areas.

16. The system of claim 15, the computer-executable instructions when executed further causing the system to:
estimate, based on a combination of the first parameter, the second parameter, the third parameter, and the demographic information, a number of migrating persons from the first area to each of the plurality of areas.

17. The system of claim 15, wherein the demographic information comprises a plurality of a set of an area information, a number of persons in the area, and a time.

18. The system of claim 16, wherein a combination of the estimated values of the first parameter, the second parameter, the third parameter, and the demographic information, maximizes a likelihood of the number of migrating persons.

19. The system of claim 15, the computer-executable instructions when executed further causing the system to:
receiving distance information between the first area and each of the plurality of areas;
generating a plurality of groups of areas based on the plurality of areas and the received distance information;
estimating, based on the demographic information and the distance information, a set of a total numbers of migrating persons from the first area to respective groups of areas; and
estimating, based on a combination of the demographic information and the estimated set of probabilities of migration of persons from the first area to each of the plurality of areas, a number of migrating persons from the first area to each of the plurality of areas.

20. The system of claim 19, wherein a combination of the estimated values of the first parameter, the second parameter, the third parameter, and the demographic information, maximizes a likelihood of the number of migrating persons.

21. The system of claim 19, wherein an area is a geographic space partitioned in a grid of a plurality of grids, the grid having a predefined distance from adjacent grids of the plurality of grids.

22. A computer-readable non-transitory recording medium storing computer-executable instructions that when executed by a processor cause a computer system to:
receive demographic information;
estimate, based on the demographic information, a first parameter, the first parameter indicating a likelihood of persons departing from a first area to one of a plurality of areas, and the plurality of areas excluding the first area;
estimate, based on the demographic information, a second parameter, the second parameter indicating a likelihood of gathering of persons in the first area from each of the plurality of areas;
estimate, based on the demographic information, a third parameter, the third parameter indicating an influence of a distance between the first area and each of the plurality of areas on a probability of migration of persons between the first area and each of the plurality of areas; and
generate, based at least on the first parameter, the second parameter, and the third parameter, a set of probabilities of migration of persons from the first area to each of the plurality of areas.

23. The computer-readable non-transitory recording medium of claim 22, the computer-executable instructions when executed further causing the system to:
estimate, based on a combination of the first parameter, the second parameter, the third parameter, and the demographic information, a number of migrating persons from the first area to each of the plurality of areas.

24. The computer-readable non-transitory recording medium of claim 22, wherein the demographic information comprises a plurality of a set of an area information, a number of persons in the area, and a time.

25. The computer-readable non-transitory recording medium of claim 23, wherein a combination of the estimated values of the first parameter, the second parameter, the third parameter, and the demographic information, maximizes a likelihood of the number of migrating persons.

26. The computer-readable non-transitory recording medium of claim 22, the computer-executable instructions when executed further causing the system to:
receiving distance information between the first area and each of the plurality of areas;
generating a plurality of groups of areas based on the plurality of areas and the received distance information;
estimating, based on the demographic information and the distance information, a set of a total numbers of migrating persons from the first area to respective groups of areas; and
estimating, based on a combination of the demographic information and the estimated set of probabilities of migration of persons from the first area to each of the plurality of areas, a number of migrating persons from the first area to each of the plurality of areas.

27. The computer-readable non-transitory recording medium of claim 26, wherein a combination of the estimated values of the first parameter, the second parameter, the third parameter, and the demographic information, maximizes a likelihood of the number of migrating persons.
